(19) United States
(12) Patent Application Publication
(10) Pub. No.: US 2014/0043447 A1
(43) Pub. Date: Feb. 13, 2014

(54) CALIBRATION IN THE LOOP

(71) Applicant: SONY CORPORATION, Minato-ku (JP)

(72) Inventors: Chao HUANG, Esslingen (DE); Yalcin INCESU, Stuttgart (DE); Piergiorgio SARTOR, Fellbach (DE); Oliver ERDLER, Ostfildern (DE); Volker FREIBURG, Stuttgart (DE)

(21) Appl. No.: 13/933,643

(22) Filed: Jul. 2, 2013

(30) Foreign Application Priority Data
Aug. 9, 2012 (EP) 12179788.0

(51) Int. Cl. H04N 13/04

(52) U.S. Cl. CPC H04N 13/0425
USPC 348/51

(57) ABSTRACT

Method for iteratively calibrating a disparity estimation process generating a disparity estimation map relating to a 3D image which consists of at least a right and a left image, the method comprising: estimating a left-to-right image disparity map of a 3D image in horizontal and vertical direction, estimating a right-to-left image disparity map of the 3D image in horizontal and vertical direction, determining a misalignment value between the left and right images on the basis of the disparity maps, feeding back the misalignment value as to be considered in the next estimating the disparity maps of a next 3D image, and repeating the method for the next 3D image to iteratively calibrate the disparity estimation process.

### BACKGROUND

1. Field of the Disclosure

The present disclosure relates to a method for iteratively calibrating a disparity estimation process generating a disparity estimation map relating to a 3D image which consists of at least a right and a left image. The present disclosure also relates to a disparity estimation device and a computer program.

2. Description of the Related Art

In stereovision systems (also called 3D systems) the depth information of objects in the scene can be obtained by estimating the disparity, i.e. the displacement of corresponding pixels in the image pair consisting of a left image and a right image. This process called disparity estimation is an essential step of stereoscopic image processing. It requires that a pixel or feature has to be searched in the other image of the image pair.

Despite achievements and efforts of researches all over the world over more than two decades, disparity estimation is still a very challenging topic. One important fact is the high computational complexity because the left and right cameras of a stereo camera capturing the image pair are in general not perfectly aligned relative to each other, with the consequence that the whole image has to be searched to find a corresponding pixel in the image pair. In other words, if the left and right cameras are perfectly aligned, the pixel can be searched in the other image in the same line, so that the search range could be limited to one line or row of the image.

In order to reduce the search range, particularly the search range in a vertical direction, as to reduce the computational complexity, a separate pre-processing step which is called stereo calibration is required. The stereo calibration computes the relative orientation between left and right cameras. Based on this information, the left and right pictures are geometrically adjusted through virtual rotation and translation of the cameras. The result is that the pixel correspondences are lying on the same horizontal line “simulating” a perfectly aligned stereo camera. This process is called rectification. Generally, stereo calibration and rectification together simplify the disparity estimation because the matching search-range is reduced from two dimensions, namely horizontal and vertical directions, to one dimension, namely only the horizontal direction. An example of this approach is shown in FIG. 3.

The most popular stereo calibration approaches are feature-based. In these approaches, feature points are extracted, typically using, for example, Harris Corner, SIFT or SURF feature extraction methods. Then the features are matched in the stereo image pair. After that, the camera parameters and relative orientation of the cameras are estimated using epipolar constraints.

One of the drawbacks of the feature-based approaches is that the feature extraction and feature matching are computationally expensive. On one hand, the stereo calibration simplifies disparity estimation, however, on the other hand, the stereo calibration itself is also very complex.

Therefore, there is a demand for further optimization with respect to computational complexity.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly or impliedly admitted as prior art against the present invention.

### SUMMARY

It is an object to provide a method for calibrating a disparity estimation process generating a disparity estimation map which is less complex.

It is a further object to provide a disparity estimation device which is also less complex and, hence, less cost-intensive.

According to an aspect, there is provided a method for iteratively calibrating a disparity estimation process generating a disparity estimation map relating to a 3D image which consists of at least a right and a left image, the method comprising:

Estimating a left-to-right image disparity map of a 3D image in horizontal and vertical direction,

Estimating a right-to-left image disparity map of the 3D image in horizontal and vertical direction,

Determining a misalignment value between the left and right images on the basis of the disparity maps,

Feeding back the misalignment value as to be considered in the next estimating the disparity maps of a next 3D image, and

Repeating the method for the next 3D image to iteratively calibrate the disparity estimation process.

According to a further aspect, there is provided a disparity estimation device comprising a disparity estimation unit adapted to generate a left-to-right horizontal and vertical disparity map and a right-to-left horizontal and vertical disparity map of a 3D image which consists of at least a left image and a right image, and a calibration unit receiving the disparity maps generated by the disparity estimation unit and adapted to determine a misalignment value indicating the misalignment between the left and the right image on the basis of the disparity maps and to feedback the misalignment value to said disparity estimation unit.

According to a further aspect, a computer program comprising program code means for causing a processor circuit to perform the steps of the afore-mentioned method when said computer program is carried out on said processor, is provided.

Preferred embodiments are defined in the dependent claims. It shall be understood that the claimed device and the claimed computer program have similar and/or identical preferred embodiments as the claimed method and as defined in the dependent claims.

One of the aspects of the present disclosure is to use the result of the disparity estimation which is carried out in a horizontal and a vertical direction to determine or calculate the misalignment value between the left and right images. The misalignment value indicates a relative camera orientation of the cameras having captured the left and right images. In the context of the present application, the misalignment value may indicate a vertical misalignment and/or a rotational misalignment, and therefore could comprise more than a single value, e.g. a matrix of n values. The misalignment value could be considered as a relative camera orientation model. This misalignment value is fed back to the disparity estimation, so that stereo calibration is performed iteratively, meaning step by step. This iterative stereo calibration allows to limit the vertical search range to a small value compared to the vertical extent of an image. Even if the vertical and/or rotational misalignment is more than the vertical search range, this misalignment is compensated for after a few iterative steps.

Due to the fact that the misalignment of cameras is not a dynamic process changing rapidly, the iterative calibration process yields a very stable result.

One of the advantages is that no feature extraction and feature matching is required which decreases costs for the stereo calibration. It is based on the disparity estimation which is processed in a feedback loop for iteratively compensating for stereo camera misalignments, so that the search range for disparity estimation is kept to a minimum.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a schematic block diagram of a disparity estimation device;

FIG. 2 shows a flow diagram for illustrating the method for iteratively calibrating a disparity estimation map; and

FIG. 3 shows a schematic block diagram of a prior art approach.

### DESCRIPTION OF THE EMBODIMENTS

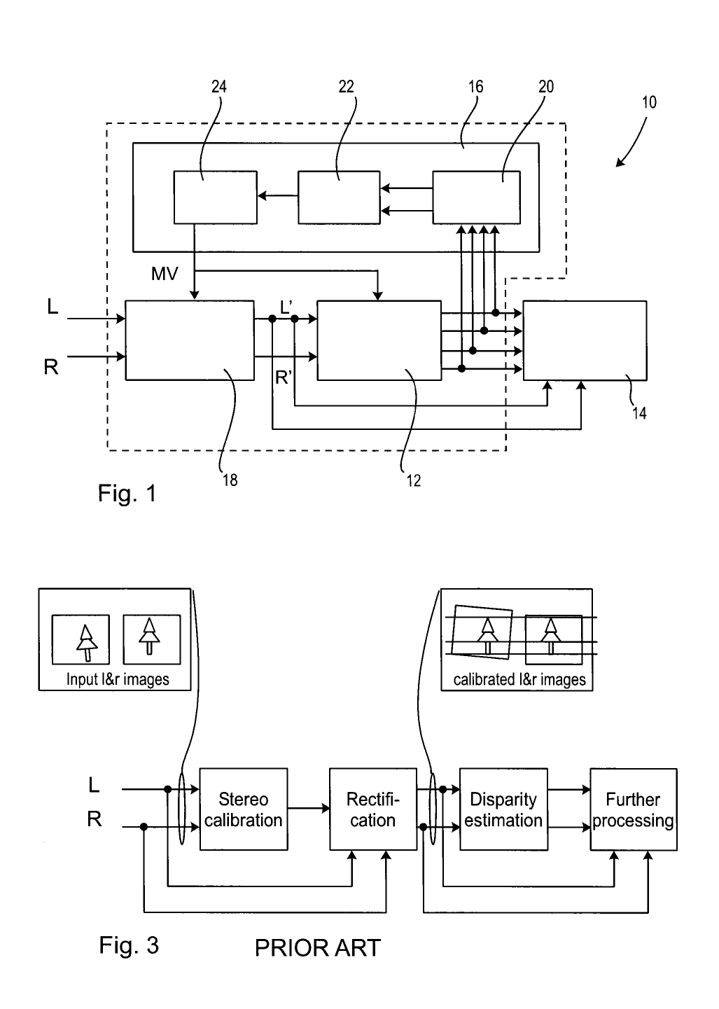

Referring now to the drawings, wherein like reference numerals designate identical or corresponding parts throughout the several views, FIG. 1 shows a block diagram of a disparity estimation device 10. Generally, this disparity estimation device is provided for estimating a disparity map on the basis of a left and a right image, which disparity map is used in a further processing component, for example for interpolating images.

The disparity estimation device comprises a disparity estimation unit 12 which receives as an input a left image L and a right image R, forming a 3D image pair. As already mentioned before, such a 3D image pair is captured by a stereo camera comprising a left camera and a right camera which are generally not perfectly aligned, for example in a vertical direction.

The output of the disparity estimation unit 12 is provided to an image processing unit 14, which, for example, generates interpolated images. The image processing unit, however, is not necessarily part of the disparity estimation device 10.

The disparity estimation device 10 further comprises a calibration unit 16 receiving the output of the disparity estimation unit 12 and outputting a misalignment value MV. This misalignment value MV is supplied back to the disparity estimation unit 12 and/or to an optionally provided rectification unit 18. This rectification unit 18 receives as input a 3D image pair (left image L, right image R) and provides as an output a rectified 3D image pair L′, R′. In the rectified 3D image pair L′, R′, the misalignment between both images is at least partially compensated for.

The rectified 3D image pair is supplied to the disparity estimation unit 12. Alternatively, if the rectification unit 18 is not provided, the disparity estimation unit receives the “unrectified” 3D image pair L, R.

As depicted in FIG. 1, the calibration unit 16 forms a feedback loop between the output of the disparity estimation unit 12 and the rectification unit 18, or the disparity estimation unit 12.

The calibration unit 16 comprises at least a consistency check unit 20, a misalignment determining unit 22 and a control unit 24.

These units 20 to 24 are coupled in series, so that the output of the consistency check unit 20 is supplied to the misalignment determining unit 22 which, in turn, supplies its output to the control unit 24. The control unit 24 provides the misalignment value MV as output, which is supplied either to the rectification unit 18 or the disparity estimation unit 12, depending whether the rectification unit 18 is provided or not.

The disparity estimation unit 12 generates so-called disparity estimation maps, wherein such a disparity estimation map comprises a disparity vector for each pixel of the left/right image. This disparity vector indicates the displacement between a pixel in one image and the corresponding pixel in the other image of the image pair.

In the present embodiment, the disparity estimation unit 12 generates four disparity estimation maps, namely a horizontal and a vertical left-to-right image disparity map and a horizontal and a vertical right-to-left image disparity map. A horizontal disparity map comprises vectors indicating the horizontal displacement, whereas a vertical disparity map comprises disparity vectors indicating the vertical displacement.

“Left-to-right” means that a corresponding pixel of the left image is searched in the right image. Hence, “right-to-left” means that a corresponding pixel of the right image is searched in the left image.

It is to be noted that the use of four disparity maps is just an example, and it would also be conceivable to combine horizontal and vertical displacements in one map, so that horizontal and vertical maps are combined to one map.

As already briefly mentioned above, the search range for matching a pixel in the left and right images extends in the vertical direction but is limited to a predetermined value, for example ±10 pixel lines.

That is, the search range can be considered as a strip-shaped region, extending over the entire horizontal length of an image and, for example, ±10 lines in vertical direction. For example, if the pixel to be searched is in the center of one image, this strip-shaped search range extends parallel to and symmetrically to a horizontal center line of the other image. Hence, with respect to the center pixel of the other image, the search range extends, for example, 10 lines up and 10 lines down. Assuming an image resolution of 1,280×720 pixels, the search range would comprise 1,280×21 pixel, hence 26,880 pixel which is only a small portion of the whole image comprising 921,600 pixel.

The left-to-right horizontal and vertical disparity maps and the right-to-left horizontal and vertical disparity maps are supplied to the calibration unit 16, and here the consistency check unit 20. The main function of the consistency check unit is to carry out a kind of disparity vector classification in reliable and non-reliable disparity vectors. A disparity vector is reliable, if the vectors for corresponding pixels in the left-to-right horizontal and vertical disparity maps and the right-to-left horizontal and vertical disparity maps are consistent. In other words, the horizontal and vertical vectors of the left-to-right disparity maps direct from the left image to the corresponding pixel in the right image and the horizontal and vertical disparity vectors in the right-to-left disparity maps for this pixel lead back to the corresponding pixel in the left image.

The consistency check unit drops the un-reliable vectors and provides as output only the reliable vectors of the disparity maps.

There are many conceivable solutions to find consistent, i.e. reliable, vectors in the left-to-right and right-to-left disparity maps. In the present embodiment, the consistency check unit is adapted to project the right-to-left horizontal and vertical disparity vectors onto the left view position and compare them to the corresponding left-to-right image disparity vectors. Vectors that have the same horizontal and vertical disparity vectors from both sides (left to right, right to left) are consistent and are, thus, classified as reliable.

On the basis of the reliable vectors, the succeeding misalignment determining unit 22 calculates a misalignment value, indicating a vertical displacement and, optionally, a rotational displacement. The misalignment value can be provided in the form of a matrix, for example a 3×3 matrix, containing several single values.

In general, the function of the misalignment determining unit 22 is to calculate a global misalignment value on the basis of a plurality of reliable vectors.

One of several conceivable approaches to calculate the misalignment is a histogram-based approach. The misalignment determining unit 22 analyzes all vertical disparity vectors and creates a histogram showing the number of vertical vectors having a vertical value between the vertical limits of the search range, here ±10.

A mean value of all reliable vertical disparity vectors is then calculated and then used as a global misalignment value. Optionally, the misalignment determining unit 22 also calculates a rotation between the left and the right image on the basis of a gradient field of the disparity vectors.

Hence, the misalignment value which is supplied to the succeeding unit, namely the control unit 24, may comprise a vertical shift value and a rotational displacement value.

The control unit 24 is provided to temporarily stabilize the calculated misalignment value, so that e.g. big changes of the misalignment value or probably oscillations of the misalignment value are avoided. The control unit 24 could, for example, be designed like a basic N-controller which is known in the art. Such a PI-controller can be described with the following equation:

G=K_{P}×Δ+K_{I}×∫Δ×dt

where K_{P} and K_{I} are proportional—and integral—coefficients, Δ is the error of actual measured value (PV) from the set-point (SP), hence

Δ=SP−PV.

The stabilized misalignment value MV is then supplied to the disparity estimation unit 12 in the preferred embodiment which does not comprise the rectification unit 18.

This misalignment value is considered in the next disparity estimation step for the next 3D image pair. The disparity estimation unit 12 can then adjust the estimation process according to the supplied misalignment value.

This iterative calibration process carried out by the calibration unit 16 in the feedback loop allows to iteratively adjust the vertical misalignment to the correct value. Even if in a first step the vertical misalignment is out of the vertical search range (e.g. ±10 lines), this actual vertical misalignment value is found in one of the next iterative steps. Due to this advantage, the search range can be limited to a value of, for example, ±10 lines in vertical direction. It is also conceivable to further limit this value, with the only consequence that the correct misalignment value can be found only in some further iterative steps. However, to ensure the effectiveness of the iterative calibration process and also to cover the relative rotation between left and right images, i.e. left and right cameras, there is a minimum vertical search range of, for example, ±5 lines.

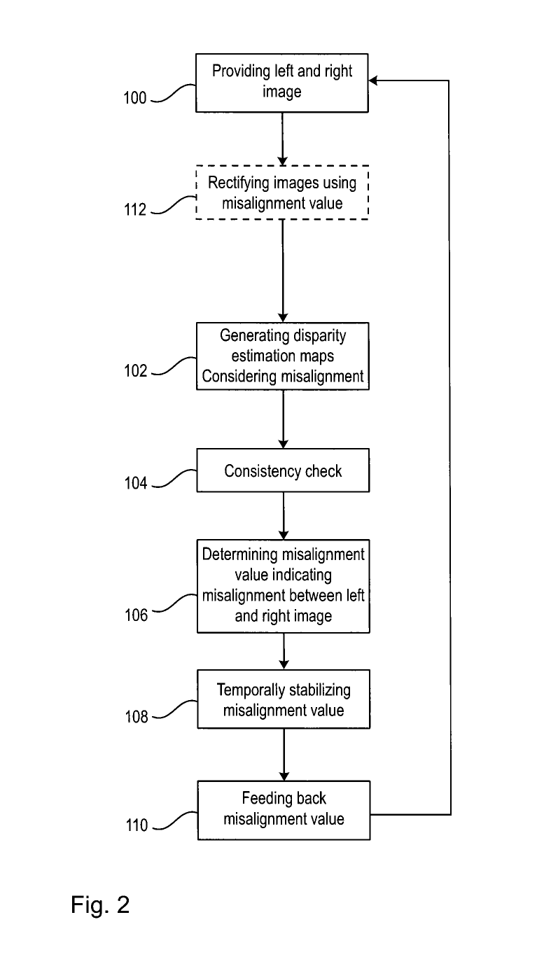

FIG. 2 shows the iterative calibration process described with reference to FIG. 1 above, in the form of a flow diagram. In a first step 100, a left and a right image are provided. Then, in step 102, the disparity estimation maps are generated, considering a misalignment value.

Then, on the basis of the disparity estimation maps, the consistency check is carried out in step 104 and then the misalignment value indicating misalignment between left and right images is determined on the basis of the reliable disparity vectors in step 106.

The misalignment value is temporarily stabilized in step 108 and is fed back in step 110.

Then, the process of calculating a misalignment value starts again on the basis of the next left and right images.

Optionally, the provided left and right images are rectified using the misalignment value in step 112, with the result that in step 102, the misalignment value does not have to be considered any more.

In summary, the present disclosure relates to a method and a corresponding device for calibrating a disparity estimation map, as to compensate for camera misalignments. Compared to the prior art feature-based stereo calibration approaches, the above-described method extracts the relative camera orientations directly from the existing results of disparity estimation and, hence, does not need feature extraction and feature matching algorithms, which are usually computational expansive. Owing to the calibration feedback loop, the disparity estimation can be carried out with a very small search range in vertical direction, although possible vertical camera misalignments could be much higher. The iterative calibration process adjusts the misalignment value to the correct value at least in a couple of iterative steps, even if the vertical misalignment is out of the vertical search range at the beginning.

Hence, this approach provides the possibility to cover vertical shifts beyond the used search range, so that hardware costs can be reduced by reducing the vertical search range.

The various elements/units of the embodiment shown in FIG. 1 may be implemented as software and/or hardware, e.g. as separate or combined circuits. A circuit is a structural assemblage of electronic components including conventional circuit elements, integrated circuits including application specific integrated circuits, standard integrated circuits, application specific standard products, and field programmable gate arrays. Further, a circuit includes central processing unites, graphic processing units, and microprocessors which are programmed or configured according to a software code. A circuit does not include pure software, although a circuit does include the above-described hardware executing software.

Obviously, numerous modifications and variations of the present disclosure are possible in light of the above teachings. It is therefore to be understood that within the scope of the appended claims, the invention may be practiced otherwise than as specifically described herein.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the invention have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present invention. Further, such a software may also be distributed in other forms, such as via the Internet or other wired or wireless telecommunication systems.

Any reference signs in the claims should not be construed as limiting the scope.

The present application claims priority of European Patent Application 12 179 788.0, filed in the European Patent Office on Aug. 9, 2012, the entire contents of which being incorporated herein by reference.

1. Method for iteratively calibrating a disparity estimation process generating a disparity estimation map relating to a 3D image which consists of at least a right and a left image, the method comprising:
Estimating a left-to-right image disparity map of a 3D image in horizontal and vertical direction,
Estimating a right-to-left image disparity map of the 3D image in horizontal and vertical direction,
Determining a misalignment value between the left and right images on the basis of the disparity maps,
Feeding back the misalignment value as to be considered in the next estimating the disparity maps of a next 3D image, and
Repeating the method for the next 3D image to iteratively calibrate the disparity estimation process.

2. Method of claim 1, wherein said misalignment value comprises a vertical shift value indicating a vertical misalignment between the left and right images and/or a rotational value indicating a rotation between the left and right images.

3. Method of claim 1, wherein determining a misalignment value comprises:
Determining mismatches between the left-to-right image disparity map and the right-to-left disparity map, and
Considering the vectors of the disparity maps as reliable which are not determined as mismatches.

4. Method of claim 3, wherein determining mismatches comprises:
Projecting disparity vectors of right-to-left disparity map onto the corresponding left view position in the left-to right disparity map,
Comparing the right-to-left disparity vectors to the corresponding left-to right disparity vectors, and
Considering those disparity vectors as reliable which have the same horizontal and vertical disparity value both in the right-to-left disparity map and the left-to-right disparity map.

5. Method of claim 1, wherein each disparity map comprises a vertical disparity and a horizontal disparity.

6. Method of claim 5, wherein said left-to right and right-to-left disparity maps each comprises a vertical disparity map and a horizontal disparity map.

7. Method of claim 3, wherein determining a misalignment value further comprises evaluating the reliable vectors to determine a global misalignment between the left and right images.

8. Method of claim 7, wherein said evaluating comprises generating a mean value of the vertical value of the reliable vectors of one of the disparity maps, the mean value indicating a vertical misalignment value.

9. Method of claim 7, wherein said evaluating comprises generating a gradient field of the reliable vectors of one of the disparity maps to extract a rotational misalignment value.

10. Method of claim 1, wherein said misalignment value is temporal stabilized when feeding back.

11. Method of claim 1, wherein said misalignment value is considered when estimating the disparity maps for the next 3D image to compensate for the misalignment in the disparity maps.

12. Method of claim 2, wherein said misalignment value is used to rectify the left or the right image of the next 3D image to compensate for the misalignment before estimating the disparity maps.

13. Method of claim 1, wherein estimating a disparity map comprises using a search field extending in vertical direction and being limited to a predefined value being less than the vertical dimension of the image.

14. Disparity estimation device comprising
a disparity estimation unit adapted to generate a left-to-right horizontal and vertical disparity map and a right-to-left horizontal and vertical disparity map of a 3D image which consists of at least a left image and a right image, and
a calibration unit receiving the disparity maps generated by the disparity estimation unit and adapted to determine a misalignment value indicating the misalignment between the left and the right image on the basis of the disparity maps and to feed back the misalignment value to said disparity estimation unit.

15. Disparity estimation device of claim 14, comprising a rectification unit connected to the disparity estimation unit and the calibration unit to receive the misalignment value and adapted to rectify one of said left and right images of said 3D image on the basis of the misalignment value to compensate for a misalignment, wherein said rectified 3D image is supplied to the disparity estimation unit.

16. Disparity estimation device of claim 14, wherein said calibration unit comprises a consistency check unit receiving the disparity maps from the disparity estimation unit and adapted to determine reliable disparity vectors in the disparity maps.

17. Disparity estimation device of claim 16, wherein said calibration unit comprises a misalignment determining unit coupled with the consistency check unit and adapted to determine a misalignment value on the basis of the reliable disparity vectors.

18. Disparity estimation device of claim 17, wherein said calibration unit comprises a control unit coupled with the misalignment determining unit and adapted to temporally stabilize the misalignment value provided by the misalignment determining unit.

19. A non-transitory computer program comprising program code means for causing a processor circuit to perform the steps of said method as claimed in claim 1 when said computer program is carried out on said processor.
